(19) United States
(12) Patent Application Publication
(10) Pub. No.: US 2021/0153118 A1
(43) Pub. Date: May 20, 2021

(54) METHOD FOR REFERRING TO APPLICATION SCENARIO TO MANAGE HARDWARE COMPONENT OF ELECTRONIC DEVICE AND ASSOCIATED NON-TRANSITORY MACHINE-READABLE MEDIUM

(71) Applicant: MEDIATEK INC., Hsin-Chu (TW)

(72) Inventors: Wang-Hsin Kuo, Hsinchu City (TW); Sheng-Kai Chang, Hsinchu City (TW)

(21) Appl. No.: 16/862,596

(22) Filed: Apr. 30, 2020

Related U.S. Application Data
(60) Provisional application No. 62/937,831, filed on Nov. 20, 2019.

(51) Int. Cl. H04W 52/02

(52) U.S. Cl. CPC H04W 52/0216; H04W 52/0254

(57) ABSTRACT

A hardware management method includes: checking an application on an electronic device to categorize a scenario of the application into a pre-defined application scenario, and during a period in which the application is running on the electronic device, managing a hardware component of the electronic device in response to the pre-defined application scenario. For example, the hardware component may be a modulator-demodulator (modem).

### CROSS REFERENCE TO RELATED APPLICATIONS

This application claims the benefit of U.S. provisional application No. 62/937,831, filed on Dec. 20, 2019 and incorporated herein by reference.

### BACKGROUND

The present invention relates to hardware management, and more particularly, to a method for referring to an application scenario to manage a hardware component of an electronic device and an associated non-transitory machine-readable medium.

In the current design, a modulator-demodulator (modem) of a wireless communication device (e.g., a cellular phone) supports many low-power tricks to reduce its power consumption. However, it is not easy to implement the power reduction function without penalty introduced. For example, network traffic is monitored by the modem to determine whether to enable the power reduction function. Since no upper layer information is involved in controlling enablement of the power reduction function of the modem, the overall system performance may be degraded.

Thus, there is a need for an innovative hardware management design which can help the modem to apply these low-power tricks more aggressively.

### SUMMARY

One of the objectives of the claimed invention is to provide a method for referring to an application scenario to manage a hardware component of an electronic device and an associated non-transitory machine-readable medium.

According to a first aspect of the present invention, an exemplary hardware management method is disclosed. The exemplary hardware management method includes: checking an application on an electronic device to categorize a scenario of the application into a pre-defined application scenario, and during a period in which the application is running on the electronic device, managing a hardware component of the electronic device in response to the pre-defined application scenario.

According to a second aspect of the present invention, an exemplary non-transitory machine-readable medium is disclosed. The exemplary non-transitory machine-readable medium stores a program code that, when executed by a processing circuit, causes the processing circuit to perform following steps: checking an application on an electronic device to categorize a scenario of the application into a pre-defined application scenario, and during a period in which the application is running on the electronic device, managing a hardware component of the electronic device in response to the pre-defined application scenario.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic device according to an embodiment of the present invention.

FIG. 2 is a flowchart illustrating a hardware management method according to an embodiment of the present invention.

FIG. 3 is a flowchart illustrating a static information based low latency application detection method according to an embodiment of the present invention.

FIG. 4 is a flowchart illustrating a dynamic information based low latency application detection method according to an embodiment of the present invention.

FIG. 5 is a flowchart illustrating an application scenario categorization method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

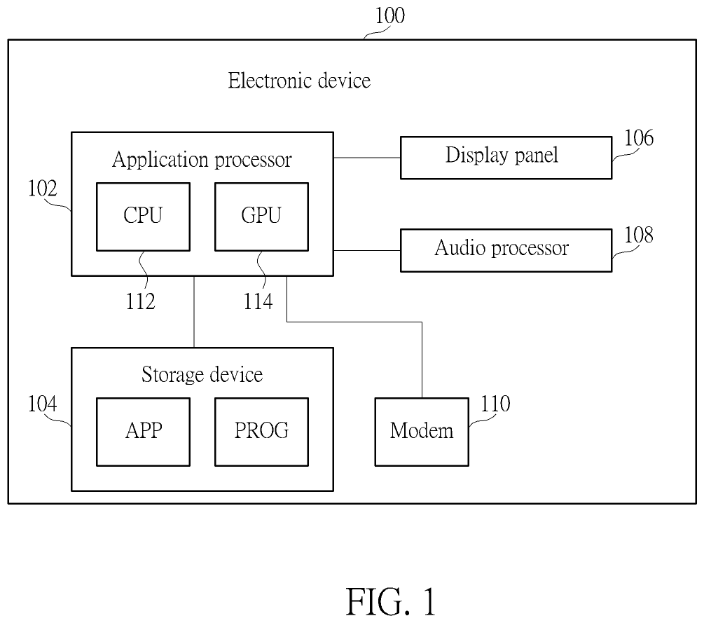

FIG. 1 is a block diagram illustrating an electronic device according to an embodiment of the present invention. By way of example, but not limitation, the electronic device 100 may be a wireless communication device such as a cellular phone, a wearable device, or a tablet. In this embodiment, the electronic device 100 may include an application processor 102, a storage device 104, a display panel 106, an audio processor 108, and a modulator-demodulator (modem) 110. The modem 110 may be a part of a wireless communication module (not shown) capable of performing wireless communication with other devices. The application processor 102 may include a plurality of processing circuits such as a central processing unit (CPU) 112 and a graphic processing unit (GPU) 114. In practice, the application processor 102 may have more than one CPU 112 and/or more than one GPU 114, depending upon actual design considerations. The storage device 104 is a non-transitory machine-readable medium. For example, the storage device may be a volatile memory, a non-volatile memory, or a combination of a volatile memory and a non-volatile memory. For another example, the storage device 104 may be an on-chip memory, an off-chip memory, or a combination of an on-chip memory and an off-chip memory. An application APP consisting of instructions may be stored in the storage device 104. In practice, more than one application APP may be stored in the storage device 104, depending upon actual design considerations. When loaded and executed by the CPU 112, the application APP instructs the CPU 112 to perform its designated functions. In addition, a program code PROG consisting of instructions may also be stored in the storage device 104. When loaded and executed by the CPU 112, the program code PROG instructs the CPU 112 to perform the proposed hardware management method. It should be noted that only the function blocks pertinent to the present invention are illustrated in FIG. 1. In practice, the electronic device 100 may include additional blocks for performing other functions.

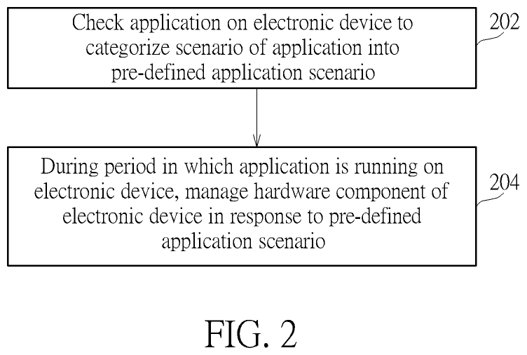

FIG. 2 is a flowchart illustrating a hardware management method according to an embodiment of the present invention. Provided that the result is substantially the same, the steps are not required to be executed in the exact order. Moreover, additional steps may be inserted. When loaded and executed by the CPU 112, the program code PROG may check the application APP on the electronic device 100 to categorize a scenario of the application APP into a pre-defined application scenario (Step 202). For example, the pre-defined application scenario may be a low throughput scenario, a high throughput scenario, a low latency scenario (e.g. a gaming scenario, a live streaming scenario, a video conference scenario, a ticket booking scenario, a telesurgery scenario, a stock ordering scenario, or an online auction scenario) , or a non-low latency scenario (e.g., a social media messaging scenario, an online food ordering and delivery scenario, an online shopping scenario, or a photographing scenario). During a period in which the application APP is running on the electronic device 100, the program code PROG running on the CPU 112 may manage a hardware component of the electronic device 100 in response to the pre-defined application scenario (Step 204) . For example, the hardware component may be one of CPU 112, GPU 114, display panel 106, audio processor 108, and modem 110, depending upon actual design considerations.

Regarding the application scenario categorization at step 202, the program code PROG may detect a user interface (UI) behavior of the application APP running on the electronic device 100. For example, foreground UI type (e.g., web view or list view) and/or foreground UI event (e.g., input method) may be checked by the program code PROG to determine whether the application APP running on the electronic device 100 is operating under a low throughput scenario or a high throughput scenario. In a case where the scenario of the application APP is categorized into the low throughput scenario, it can imply that the APP may only need the modem 110 to provide a low network throughput. In another case where the scenario of the application APP is categorized into the high throughput scenario, it can imply that the APP may need the modem 110 to provide a high network throughput.

In a streaming case, the program code PROG may check a video codec (coder and decoder), a streaming status, and/or a video buffer status. For example, when the video codec is in operation, the streaming is idle, and the video buffer is full, it can imply that the video codec may directly read video data from the video buffer for decoding and then output decoded frames to the display panel 106. At this moment, the modem 110 does not need to receive the video data from a streaming source, such that the network throughput of the modem 110 is low. Hence, the program code PROG may judge that the application APP running on the electronic device 100 is operating under a low throughput scenario.

In an instant messaging case, the program code PROG may judge that the application APP running on the electronic device 100 is operating under a low throughput scenario when the application APP adopts a list view which groups several items and displays them in a vertical scrollable list on the UI. At this moment, the modem 110 does not need to receive the video data from a streaming source, such that the network throughput of the modem 110 is low.

In another instant messaging case, the program code PROG may judge that the application APP running on the electronic device 100 is operating under a high throughput scenario when the application APP adopts a surface view for live streaming. At this moment, the modem 110 needs to receive the video data from a streaming source, such that the network throughput of the modem 110 is high.

In a browser case, the program code PROG may judge that the application APP running on the electronic device 100 is operating under a low throughput scenario when the application APP adopts a web view for displaying a completely loaded web content. At this moment, the modem 110 does not need to receive the video data from a web server, such that the network throughput of the modem 110 is low.

It should be noted that the scenario of the application APP may vary, depending upon a current function enabled by the application APP running on the electronic device 100. That is, when a first function of the application APP running on the electronic device 100 is enabled by the user, the program code PROG may judge that the application APP is operating under one pre-defined application scenario, and when a second function of the application APP running on the electronic device 100 is enabled by the user, the program code PROG may judge that the application APP is operating under another pre-defined application scenario. For example, considering a case where the application APP is a social media application, the scenario of the application APP running on the electronic device 100 may be categorized into a low throughput scenario when the user is using a messaging function of the application APP, and may be categorized into a low latency scenario when the user is using a video call function of the application APP.

Furthermore, in some embodiments of the present invention, a game application may be treated as a low latency application that operates under a low latency scenario, and a non-game application may be treated as a non-low latency application that operates under a non-low latency scenario. Hence, with regard to certain applications, a type of an application may also imply a scenario of the application running on an application processor. To put it another way, an application scenario may be determined through detecting an application type.

Regarding the application scenario categorization at step 202, the program code PROG may detect if the application APP is a low latency application, such as a game application. For example, static information of the application APP and/or dynamic information of the application APP may be checked to determine if the application APP is a low latency application, where the static information of the application APP is fixed during runtime of the application APP, and dynamic information of the application APP is not fixed during runtime of the application APP.

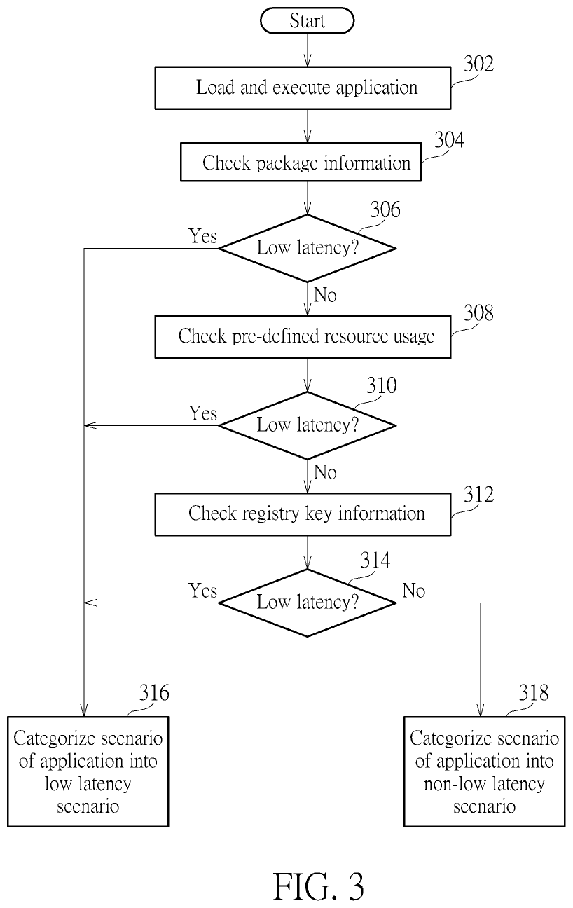

FIG. 3 is a flowchart illustrating a static information based low latency application detection method according to an embodiment of the present invention. Provided that the result is substantially the same, the steps are not required to be executed in the exact order shown in FIG. 3. Moreover, additional steps may be inserted. The static information based low latency application detection method may be performed by the program code PROG running on the CPU 112. At step 302, an application (e.g., application APP) may be loaded and executed by the CPU 112. For example, the application (e.g., application APP) may be an Android application or an application of other platform. In some embodiments of the present invention, the application (e.g., application APP) at step 302 may be a new application that is executed for the first time since installation. In some embodiments of the present invention, the application (e.g., application APP) at step 302 may be an updated application that is executed for the first time since latest version update.

At step 304, the program code PROG may check package information of the application (e.g., application APP). At step 306, the program code PROG may refer to the package information of the application (e.g., application APP) to determine if the application (e.g., application APP) is a low latency application, such as a game application. For example, when the application (e.g., application APP) has a package name with a keyword “game” or “tmgp”, the scenario of the application (e.g., application APP) can be categorized into a low latency scenario (Step 316) because “game” or “tmgp” may imply the application is a game application. For example, when the application (e.g., application APP) has an activity name with a keyword “game”, the scenario of the application (e.g., application APP) can be categorized into a low latency scenario (Step 316) because “game” may imply the application is a game application. For yet another example, when a manifest Extensible Markup Language (XML) file of the application (e.g., application APP) records a flag “isGame”, a game identifier (ID) and/or an application category that is set by “game”, the scenario of the application (e.g., application APP) can be categorized into a low latency scenario (Step 316) because “isGame” or “game” may imply the application is a game application.

If the package information of the application (e.g., application APP) does not hint that the application (e.g., application APP) is a low latency application, the flow proceeds with step 308. At step 308, the program code PROG may refer to the pre-defined resource usage of the application (e.g., application APP) to determine if the application (e.g., application APP) is a low latency application. For example, when a manifest XML file of the application (e.g., application APP) records that the application is written with a game engine or a game library, the scenario of the application (e.g., application APP) can be categorized into a low latency scenario because the application may be a game application (Step 316).

If the pre-defined resource usage of the application (e.g., application APP) does not hint that the application (e.g., application APP) is a low latency application, the flow proceeds with step 312. At step 312, the program code PROG may refer to the registry key information of the application (e.g., application APP) to determine if the application (e.g., application APP) is a low latency application. When the registry key information is indicative of a low latency application, the scenario of the application (e.g., application APP) can be categorized into a low latency scenario (Step 316). When the registry key information is not indicative of a low latency application, the scenario of the application (e.g., application APP) can be categorized into a non-low latency scenario (Step 318).

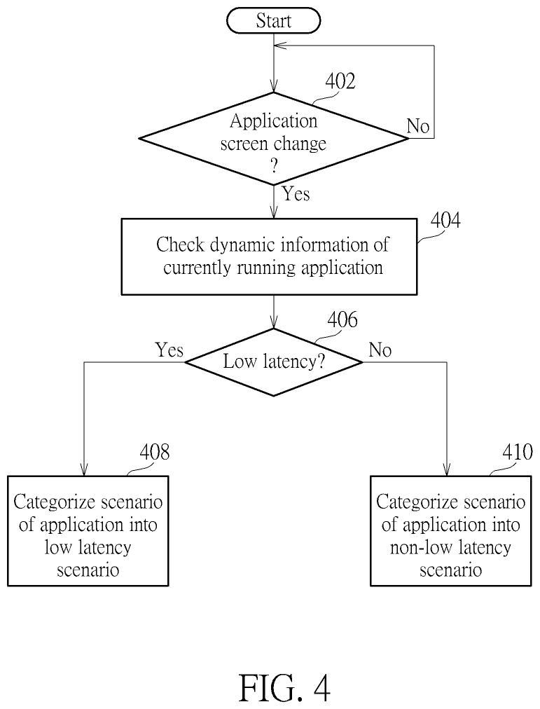

FIG. 4 is a flowchart illustrating a dynamic information based low latency application detection method according to an embodiment of the present invention. Provided that the result is substantially the same, the steps are not required to be executed in the exact order shown in FIG. 4. Moreover, additional steps may be inserted. The dynamic information based low latency application detection method may be performed by the program code PROG running on the CPU 112. At step 402, the program code PROG may check if an application screen change occurs. If the application screen change does not occur, the program code PROG may keep checking occurrence of application screen change. If an application screen change occurs, a new application screen may be displayed on the display panel 106. For example, the application screen may change due to the fact that a new activity used to interact with a user is displayed on the UI. It is possible that a currently running application (e.g., application APP) may enter a low latency mode (e.g., game mode) to trigger an application screen change event. Hence, checking dynamic information of the currently running application (e.g., application APP) may be enabled to check if the currently running application (e.g., application APP) enters a low latency application mode (Step 404).

At step 404, the program code PROG may check at least one of static information of the new application screen/activity, GPU usage, a run status of a game engine, and a status of network socket connection. That is, the dynamic information of the currently running application (e.g., application APP) may include static information of the new application screen/activity and/or application resource usage change. At step 406, the program code PROG may refer to the dynamic information of the currently running application (e.g., application APP) to determine if the currently running application (e.g., application APP) is a low latency application, such as a game application. When the dynamic information of the currently running application (e.g., application APP) indicates that the currently running application (e.g., application APP) is a low latency application, the scenario of the currently running application (e.g., application APP) can be categorized into a low latency scenario (Step 408). When the dynamic information of the currently running application (e.g., application APP) does not indicate that the currently running application (e.g., application APP) is a low latency application, the scenario of the currently running application (e.g., application APP) can be categorized into a non-low latency scenario (Step 410).

In one exemplary design, the application scenario categorization at step 202 shown in FIG. 2 may include detecting the UI behavior of the application APP running on the electronic device 100 for high/low throughput scenario detection. In another exemplary design, the application scenario categorization at step 202 shown in FIG. 2 may include detecting if the application APP is a low latency application for low latency scenario detection by using, for example, the static information based low latency application detection method shown in FIG. 3 and/or the dynamic information based low latency application detection method shown in FIG. 4. In yet another exemplary design, the application scenario categorization at step 202 shown in FIG. 2 may include detecting if the application APP is a low latency application and detecting the UI behavior of the application APP running on the electronic device 100, where low latency application detection may employ the static information based low latency application detection method shown in FIG. 3 and/or the dynamic information based low latency application detection method shown in FIG. 4.

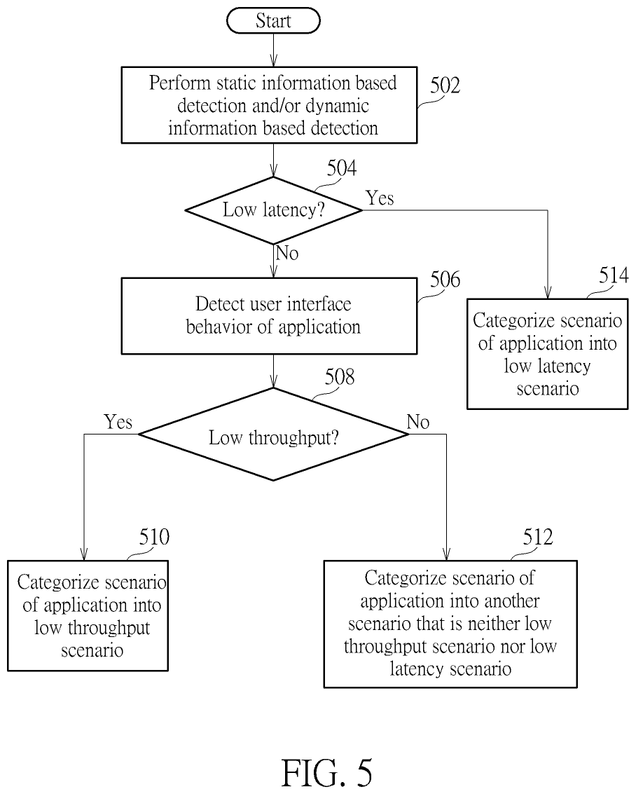

FIG. 5 is a flowchart illustrating an application scenario categorization method according to an embodiment of the present invention. Provided that the result is substantially the same, the steps are not required to be executed in the exact order shown in FIG. 5. Moreover, additional steps maybe inserted. The step 202 shown in FIG. 2 may employ the application scenario categorization method shown in FIG. 5. At step 502, the program code PROG may perform the static information based low latency application detection method shown in FIG. 3 and/or the dynamic information based low latency application detection method shown in FIG. 4. If the low latency application detection result indicates that the application APP is a low latency application, the program code PROG can categorize the scenario of the application APP into a low latency scenario (e.g. gaming scenario) (Steps 504 and 514). If the low latency application detection result does not indicate that the application APP is a low latency application, the flow proceeds with step 506. At step 506, the program code PROG may detect the UI behavior of the application APP running on the electronic device 100. If the UI behavior detection result indicates that the application APP does not require a high throughput of network packet communication, the program code PROG can categorize the scenario of the application APP into a low throughput scenario (Steps 508 and 510). If the UI behavior detection result indicates that the application APP requires a high throughput of network packet communication, the program code PROG can categorize the scenario of the application APP into another application scenario (e.g., high throughput scenario) that is neither low latency scenario nor low throughput scenario (Steps 508 and 512).

After the scenario of the application APP is categorized into a pre-defined application scenario at step 202, the application scenario categorization result can be referenced for managing a hardware component of the electronic device 100 at step 204. In a first exemplary design, power consumption of the hardware component can be managed in response to the pre-defined application scenario. For example, the hardware component may be the modem 110, and power consumption of the modem 110 can be reduced under a condition that the scenario of the application APP is categorized into the low throughput scenario. For another example, the hardware component may be the display panel 106, and power consumption of the display panel 106 can be reduced under a condition that the scenario of the application APP is categorized into the low throughput scenario.

In a second exemplary design, computing power of the hardware component can be managed in response to the pre-defined application scenario. For example, the hardware component may be the CPU 112, and computing power of the CPU 112 can be enhanced under a condition that the scenario of the application APP is categorized into the low latency scenario (e.g. gaming scenario). For another example, the hardware component may be the GPU 114, and computing power of the GPU 114 can be enhanced under a condition that the scenario of the application APP is categorized into the low latency scenario (e.g. gaming scenario).

In a third exemplary design, video shading offered by the hardware component can be managed in response to the pre-defined application scenario. For example, video shading offered by the hardware component may be enhanced under some application scenarios that require high visual quality.

In a fourth exemplary design, audio quality offered by the hardware component can be managed in response to the pre-defined application scenario. For example, the hardware component may be the audio processor 108, and audio quality offered by the audio processor 108 can be lowered under some application scenarios that do not need high quality audio playback.

It should be noted that the above are for illustrative purposes only, and are not meant to be limitations of the present invention. In practice, an electronic device may use an application scenario categorization result to manage a hardware component for achieving other purpose. These alternative designs all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A hardware management method comprising:
checking an application on an electronic device to categorize a scenario of the application into a pre-defined application scenario; and
during a period in which the application is running on the electronic device, managing a hardware component of the electronic device in response to the pre-defined application scenario.

2. The hardware management method of claim 1, wherein checking the application on the electronic device comprises:
detecting a user interface (UI) behavior of the application running on the electronic device.

3. The hardware management method of claim 1, wherein checking the application on the electronic device comprises:
detecting if the application is a low latency application.

4. The hardware management method of claim 3, wherein detecting if the application is the low latency application comprises:
checking static information of the application, wherein said static information is fixed during runtime of the application.

5. The hardware management method of claim 4, wherein said static information comprises at least one of package information, pre-defined resource usage, and registry key information.

6. The hardware management method of claim 3, wherein detecting if the application is the low latency application comprises:
checking dynamic information of the application running on the electronic device, wherein said dynamic information is not fixed during runtime of the application.

7. The hardware management method of claim 6, wherein checking said dynamic information of the application is performed in response to an application screen change.

8. The hardware management method of claim 7, wherein said dynamic information comprises at least one of static information of a new application screen, graphic processing unit (GPU) usage, a run status of a game engine, and a status of network socket connection.

9. The hardware management method of claim 1, wherein the hardware component is a modulator-demodulator (modem).

10. The hardware management method of claim 1, wherein managing the hardware component comprises:
managing power consumption of the hardware component, computing power of the hardware component, video shading offered by the hardware component, or audio quality offered by the hardware component.

11. A non-transitory machine-readable medium storing a program code that, when executed by a processing circuit, causes the processing circuit to perform following steps:
checking an application on an electronic device to categorize a scenario of the application into a pre-defined application scenario; and
during a period in which the application is running on the electronic device, managing a hardware component of the electronic device in response to the pre-defined application scenario.

12. The non-transitory machine-readable medium of claim 11, wherein checking the application on the electronic device comprises:
detecting a user interface (UI) behavior of the application running on the electronic device.

13. The non-transitory machine-readable medium of claim 11, wherein checking the application on the electronic device comprises:
detecting if the application is a low latency application.

14. The non-transitory machine-readable medium of claim 13, wherein detecting if the application is the low latency application comprises:
checking static information of the application, wherein said static information is fixed during runtime of the application.

15. The non-transitory machine-readable medium of claim 14, wherein said static information comprises at least one of package information, pre-defined resource usage, and registry key information.

16. The non-transitory machine-readable medium of claim 13, wherein detecting if the application is the low latency application comprises:
checking dynamic information of the application running on the electronic device, wherein said dynamic information is not fixed during runtime of the application.

17. The non-transitory machine-readable medium of claim 16, wherein checking said dynamic information of the application is performed in response to an application screen change.

18. The non-transitory machine-readable medium of claim 17, wherein said dynamic information comprises at least one of static information of a new application screen, graphic processing unit (GPU) usage, a run status of a game engine, and a status of network socket connection.

19. The non-transitory machine-readable medium of claim 11, wherein the hardware component is a modulator-demodulator (modem).

20. The non-transitory machine-readable medium of claim 11, wherein managing the hardware component comprises:
managing power consumption of the hardware component, computing power of the hardware component, video shading offered by the hardware component, or audio quality offered by the hardware component.
